(19) United States
(12) Patent Application Publication
(10) Pub. No.: US 2011/0131083 A1
(43) Pub. Date: Jun. 2, 2011

(54) METHOD AND APPARATUS FOR PARKING LOT MANAGEMENT

(75) Inventors: William Gibbens Redmann, Glendale, CA (US); Chris Outwater, Santa Barbara, CA (US)

(73) Assignee: Liberty Pluglns, Inc.

(21) Appl. No.: 12/957,348

(22) Filed: Nov. 30, 2010

Related U.S. Application Data
(60) Provisional application No. 61/265,440, filed on Dec. 1, 2009.

(51) Int. Cl. G06F 17/30; G06Q 10/00

(52) U.S. Cl. 705/13; 707/812; 707/E17.044

(57) ABSTRACT

Systems and methods for associating a parking lot parking entry event and a parking lot electric vehicle charging event allow a single payment to be calculated for parking and electric vehicle charging. An admittance identification associated with a parking lot entry event is read using an electric vehicle charging control device of a parking lot. A parking lot charging event is stored with the admittance identification on a storage device of the parking lot using the electric vehicle charging control device. The parking lot entry event and the parking lot charging event associated with the admittance identification are read from the storage device using a payment device of the parking lot. A single payment for parking and electric vehicle charging for the admittance identification is then calculated from the parking lot entry event and the parking lot charging event using the payment device.

### CROSS-REFERENCE TO RELATED APPLICATION

This application claims the benefit of U.S. Provisional Patent Application No. 61/265,440, filed Dec. 1, 2009, which is incorporated by reference herein in its entirety.

### BACKGROUND

1. Field of the Invention

The present invention relates to a system and method for managing a parking lot having EV charging stations.

2. Description of the Problem

There are a growing number of plug-in electric vehicles (PEVs) and plug-in hybrid vehicles (PHEVs) on the roads of the world. For the sake of this discussion, we refer to all of these vehicles simply as electric vehicles, or EVs. This growing population of EVs will require a rich charging environment, allowing them to plug in and charge under various conditions and times and places during the night and day.

Several companies have begun to supply charging site infrastructure for EVs. These companies are providing their own infrastructure for metering, timing, and billing their customers. These companies often revenue share with city government or private parking lot owners.

EV charging is intrinsically tied to parking: other than hybrid-electric vehicles, EVs must be parked to be charged, and even PHEVs exhibit better economy and a lower carbon footprint when charged from the plug rather than from their fuel-driven generator.

Large parking structures and parking lots frequently use automated gates with parking ticket dispensers at the entrance(s), and various mechanisms for managing exits. In modern system, these tickets are machine-readable.

The classic arrangement is a booth at a gated exit, manned by a clerk who accepts tickets from exiting patron, presents the ticket to be read by a register, collects payment from the patron and enters it into the register, after which the parking management system operates the exit gate.

A more recent innovation involves automated payment kiosks generally placed to be conveniently encountered as a patron is returning to the car. Such kiosks accept a ticket presented by the patron, accept appropriate payment from the patron, and returns the ticket having noted payment in a database and printing receipt information onto the ticket (or returning a separate receipt). Returning to the car, the patron drives to an automatic exit gate and presents the ticket to the exit gate ticket reader. Upon recognizing the ticket and finding the payment record in the database, the exit gate ticket reader actuates the exit gate to allow the car to exit.

A similar interaction can occur at the exit gate ticket reader without the patron stopping first at the automated payment kiosk. Instead, the patron submits the ticket to the exit gate ticket reader, the ticket reader then accepts payment from the patron, and the ticket is returned as a receipt, noted in the database as such, and the exit gate is actuated as before.

Another aspect of such system is that some patrons, for instance the tenants of a nearby building, have longer term parking passes, e.g. a monthly pass. Such patrons have an identification card, usually machine-readable, to admit them into the parking lot instead of having to draw a parking ticket, and to let them out of the parking lot, since their machine-readable identification card is recognized as being authorized to park without on-the-spot payment.

Another aspect of present-day parking system is that businesses neighboring the parking lot may offer validated parking, that is by specially marking the card, e.g. with a sticker, an ink stamp, or punch; or noting in the database record associated with the card that it has been validated and by whom. The payment required by the clerk is reduced in accordance with the parking lot policies for the validation. Similarly, if the validation is machine-readable or has already been entered into the database, then the payment kiosk or exit gate ticker reader can reduce payment appropriately.

### SUMMARY OF THE INVENTION

Lacking in present-day parking systems is a way for patrons making use of EV charging systems to pay a premium for parking, since they may be receiving both parking and electrical energy to charge their vehicle, and yet take advantage of automated parking exit systems without paying additional parking fees, that is, parking and EV charging results in two payment transactions, instead of only one.

The focus of the present invention is to incorporate EV charging and billing into existing parking lot management systems such that patrons and parking lot operators engage in a convenient, single-payment transaction.

In the present invention, a patron would drive up to a parking lot entrance and take a parking ticket from an automated dispenser, thereby registering the ticket into the database with a parking start time, or the patron presents a previously issued identification card, initializing a record for that identification card with a parking start time.

If the patron doesn't make use of the EV charging facilities, then validation and payment upon departure is handled as in the prior art.

However, if the patron does make use of the EV charging facilities, then he presents the ticket or identification to an EV charging kiosk. At this point, the charging kiosk can either accept payment, or note in the database record associated with the ticket or identification that an EV charging location is being used, after which the charging outlet associated with the location is activated for use by the patron.

While the patron's vehicle is parked, the patron may receive one or more parking validations, for example at a neighboring retail location, which are registered to the ticket or identification. As the patron is leaving, checkout with the attendant, the payment kiosk, or automated exit ticket reader would result in a payment according to the policies of the parking lot, including credit for any payment or authorization made for EV charging.

### DESCRIPTION OF THE DRAWINGS

The aspects of the present invention will be apparent upon consideration of the following detailed description taken in conjunction with the accompanying drawings, in which like referenced characters refer to like parts throughout, and in which:

FIG. 1 is a plan view of a parking area under management of the present invention;

FIG. 2 is a block diagram for the parking management system;

FIG. 3 is a database suitable for use with the parking management system;

FIG. 4 is a charging kiosk;

FIG. 5 is a flowchart for the entry transaction;

FIGS. 6A and 6B are flowcharts for a charging kiosk transactions as one connects and disconnects from the charging kiosk;

FIGS. 7A and 7B are flowcharts for automatic and manual validation transactions (respectively);

FIG. 8 is a flowchart for the payment kiosk transaction;

FIG. 9 is a flowchart for the exit transaction

FIG. 10 is a plan view of a parking area under management of the present invention, the parking area having a gated EV charging area; and,

FIGS. 11A-11E are each flowcharts for processes of managing parking lots with EV charging.

FIG. 12 is an exemplary flowchart showing a method for associating a parking lot parking entry event and a parking lot electric vehicle charging event, in accordance with various embodiments.

FIG. 13 is a schematic diagram of a system that includes one or more distinct software modules that performs a method for associating a parking lot parking entry event and a parking lot electric vehicle charging event, in accordance with various embodiments.

While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

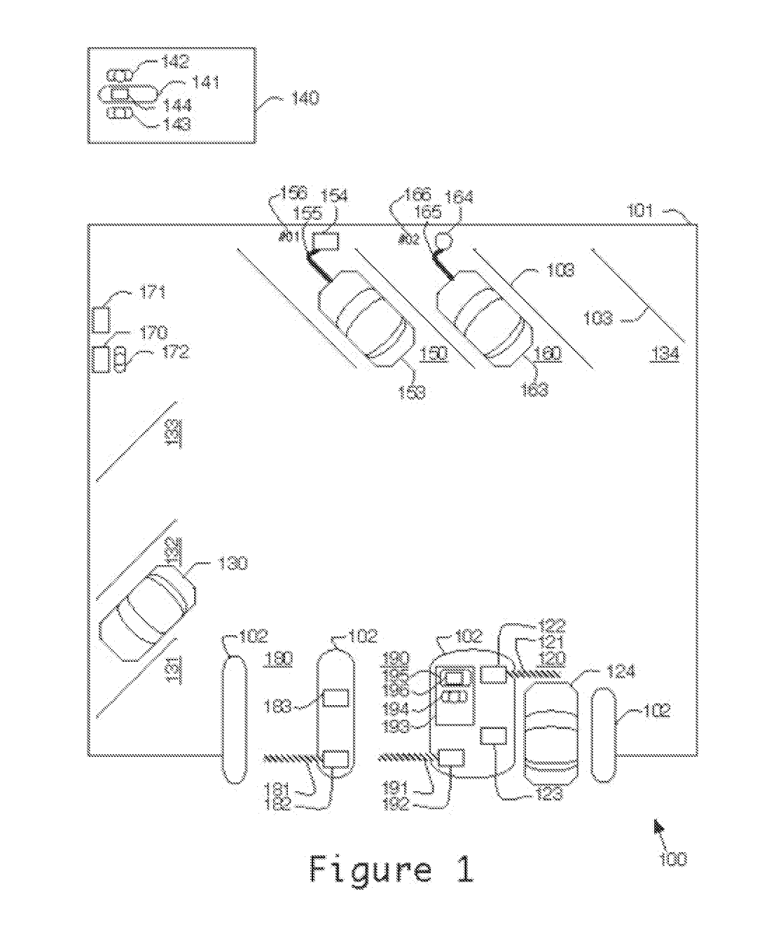

Referring to FIG. 1, parking lot 100 has perimeter 101 preventing vehicles from entering and exiting, except at entrances and exits bounded by curbs 102 or other barriers channel vehicle traffic. Lot 100 has a number of parking spaces, for example marked by lines 103, as with ordinary parking spaces 131, 132, 133, 134, and EV charging spaces 150, 160.

At parking lot entrance 120, gate 121 blocks vehicles from entering parking lot 100 until actuator 122 lifts gate 121. Automated ticket dispenser 123 issues a ticket as vehicle 124 drives up, or as the patron in vehicle 124 presses a button (not shown) on dispenser 123. When the patron in vehicle 124 takes the ticket, it is registered in a database with a “parking start time” and actuator 122 raises gate 121 to admit vehicle 124.

Alternatively, the patron may present an identification recognized by the automated ticket dispenser 123 or other device similarly located and able to read the identification, which can comprise, for example, an RFID reader able to read an RFID tag in an identification card. In this case, a record is created in the database with a “parking start time” or similar log, and the actuator 122 raises gate 121 as before.

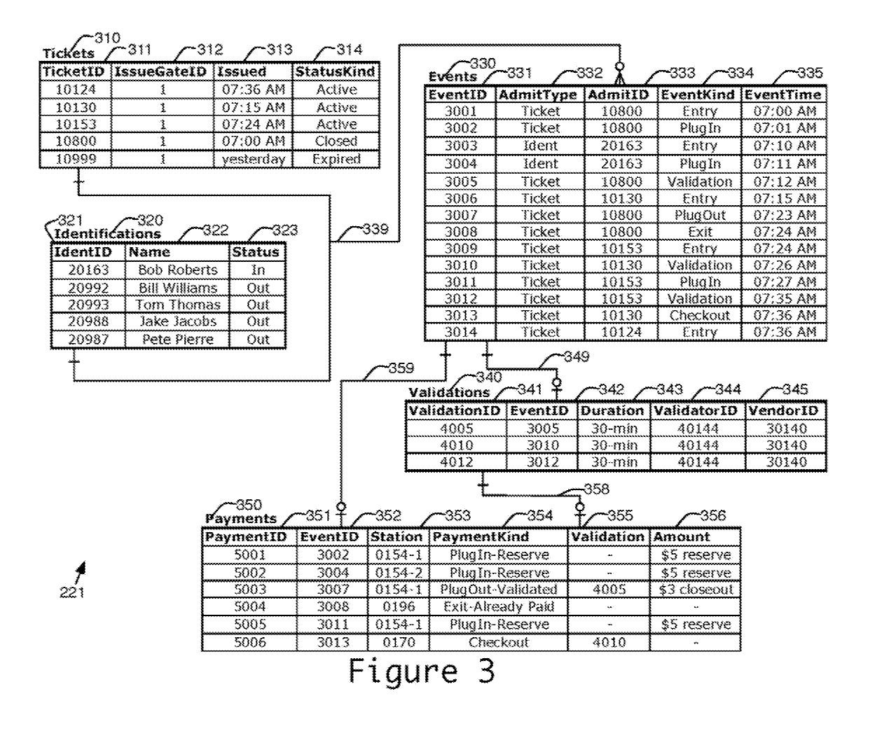

Herein, the term ‘admittance identification’ or ‘admittance ID’ refers to either a parking ticket issued by ticket dispenser 123 or an identification recognized by the automated ticket dispenser 123 or other device similarly located and able to read the identification. As will be discussed in conjunction with FIG. 3 and, therein, relationship 339, the parking management system can operate with either or both single use parking tickets, or reusable identifications, which are generically referred to as admittance IDs.

In other embodiments, the presented identification and reader may be, for example and not by way of limitation, a barcode and a barcode reader; the patron's face and a camera and face recognition system; the patron's finger and a fingerprint reader; or, the vehicle's license plate and a camera and license plate recognition system; etc.

Most vehicles (at least, in the near term) will use ordinary parking spaces 131, 132, 133, or 134, as has vehicle 130. However, patrons driving EVs may choose to parking in EV charging enabled spaces 150 or 160, as have the drivers of EVs 153 and 163.

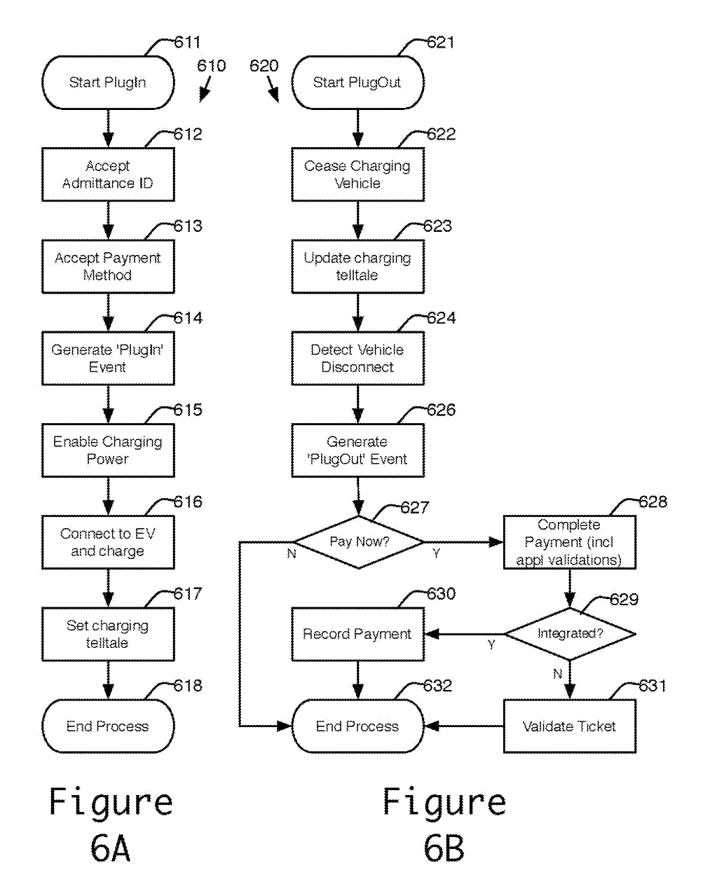

In the case of EV 153, the patron who drove it visited charging kiosk 154. He presented his ticket or identification to a reader in charging kiosk 154 initiating a transaction such as discussed below in conjunction with FIG. 6A.

Unless there is a one-to-one relationship between charging kiosk 154 and a parking space (e.g., 150) then the patron must indicate in which space (e.g., 150, 160) his vehicle is parked by indicating the space number such as, “#01” or “#02”, respectively, as indicated by indicia 156, 166, for example by pushing a corresponding button on charging kiosk 154 or by entering the space number on a keypad for kiosk 154.

Depending on a predetermined policy, the patron may be required to present a credit card or debit card so that a transaction may be initiated with an authorization hold (e.g., a reservation on the card account for the likely maximum fee for parking at the indicated parking space). Other forms of payment may be accepted, and may represent a deposit. Details of the authorization hold or payment and the use of the indicated parking space are kept in association with the ticket or identification in the database.

In another embodiment, policy may not require pre-payment authorization at this time, and the use of the indicated EV parking space is merely associated with the ticket or identification in the database.

In yet another embodiment, if the presented identification has previously been associated with an account, then whether or not the account is in good standing may be checked, and if so, the transaction with the charging kiosk 154 may be in association with the associated account.

At this point, the charging outlet of charging kiosk 154 is usable, having been enabled by kiosk 154 as part of the transaction. EV 153 is plugged in and begins charging through charging cable 155, provided either by kiosk 153 or by the patron.

The patron who drove EV 163 and parked in space 160 initiated a similar transaction, but in this example, there is not a one-to-one relationship, since charging kiosk 154 manages transactions for both parking spaces 150 and 160. This transaction, closely resembling that described above, except the driver of EV 163 indicated that he was parked in space “#02”, taken from indicia 166. As part of this transaction, charging station 164, being the charging station associated with parking space 160 and indicia 166, is enabled by charging kiosk 154. EV 163 is connected to charging station 164 with cable 165.

In some embodiments, cables 155 and 165 may have standardized couplers on them. For instance, where cables 155 and 165 connect to corresponding vehicles 153, 163, the connector may conform to the SAE J1772 standard, currently in development. At the point where the cables connect to the corresponding chargers 154 and 164, they may be permanently connected (hardwired), or may use other standard plugs and outlets (e.g., NEMA 5-15, NEMA 6-20, etc.)

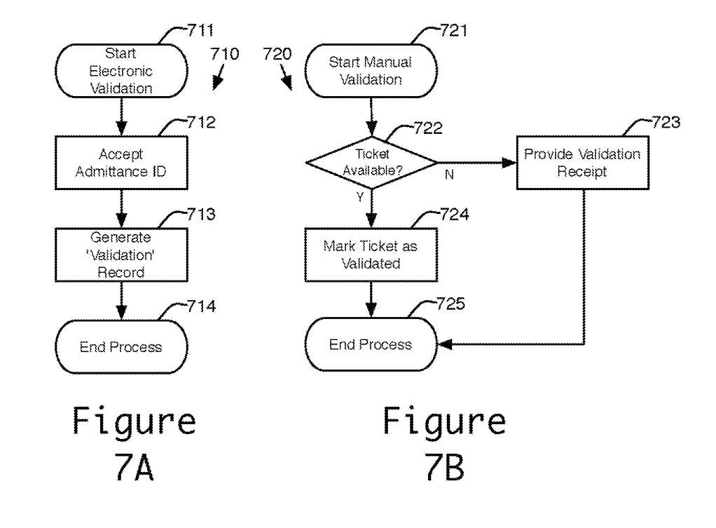

Nearby business 140 (also referred to herein as ‘vendor 140’) is an example of a neighboring merchant that offers parking validation for parking facility 100. Merchant patron 143 is also the driver of one of the cars, e.g., EV 163, in lot 100, and therefore is a parking lot patron also. Clerk 142 at counter 141 can take a parking ticket from patron 143 and validate it with validator 144. While validator 144 can be an inked stamp, a punch, or other mechanism to physically mark the parking ticket, in some embodiments validator 144 comprises a reader for the parking ticket which has communication with the database used to manage parking lot 100, including tracking the status of parking tickets. Validation transactions are discussed further, in conjunction with FIGS. 7A and 7B, below.

Prior to exiting parking lot 100, a parking lot patron presents his identification (e.g., his parking ticket) in a transaction that determines how much, if any, is due. This transaction can take place before the patron returns to his car, for example at a payment kiosk 170; as the patron returns to his car, e.g., at charging kiosk 154; as the patron is driving in automated exit lane 180 or in attended exit lane 190. These and other variations are discussed below.

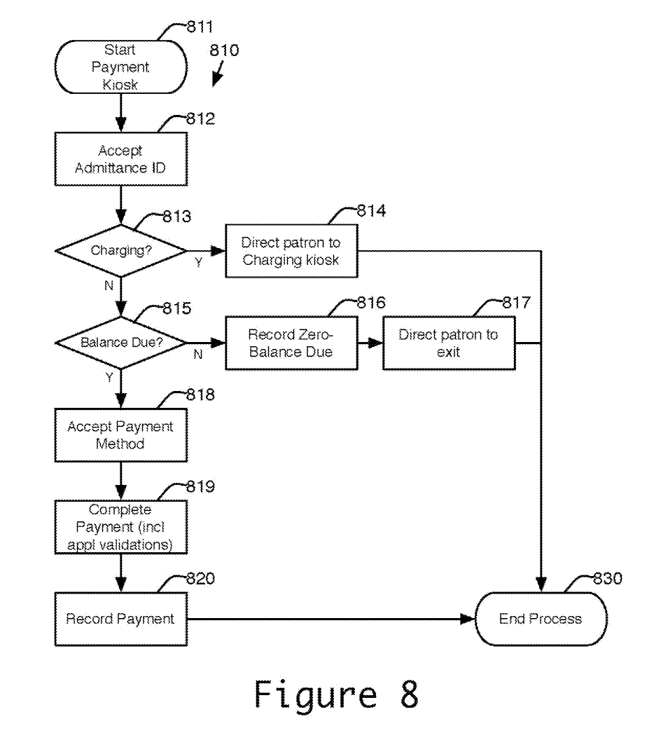

At automatic payment kiosks 170 or 171, a departing patron 172 can present his parking ticket or other identification recently presented to gain entry at entrance lane 120. Automatic payment kiosk 170 can determine from the parking ticket what, if any, fee is due for parking, taking into account whatever policies are appropriate, and including appropriate consideration for validations, e.g., from merchant 140, and whether an EV plugged in at charging station 154 or 164 is associated with the parking ticket. Such payment transactions are further discussed in conjunction with FIG. 8, below.

In an alternative embodiment, an attended cashier's window or valet station (neither shown) can be used instead of, or in addition to, an automated payment kiosk 170. In such an embodiment, an attendant accepts the parking ticket and presents it to be read by a point-of-sale register to conduct a transaction similar to that performed by automated payment kiosk 170.

In an embodiment having a valet station, a valet would have previously taken the patron's car to be parked and, at least for a portion of the vehicle's stay in the parking lot, see that it was plugged into a charging station 154, 164, or a simple electrical outlet (not shown) suitable for EV charging. The parking ticket comprises two portions, one which the patron retains and the other which the valet uses to track information regarding the vehicle, including its current parking location, charging history, and keys. As the patron returns and presents his portion of the parking ticket, the valet is not only dispatched to retrieve the patron's keys and car, but can also carry out the appropriate transaction, similar to that of automated payment kiosk 170.

In some embodiments, as a matter of policy or due to the configuration of the system, an automated payment kiosk 170 cannot complete a transaction related to a vehicle charging at charging kiosks 154 or 164. In such a case, patron 172 may be directed to return to charging kiosk 154 to complete the transaction.

Automated charging kiosk 154 may be capable of performing a payment transaction related to vehicles charging at either charging station 154 or 164, using a process such as discussed below in conjunction with FIG. 6B.

Whether or not a patron has visited automated payment kiosk 170 or charging kiosk 154 prior to attempting to exit, a check of the status related to the patron's identification or parking ticket is made in either automated exit lane 180 or attended exit lane 190.

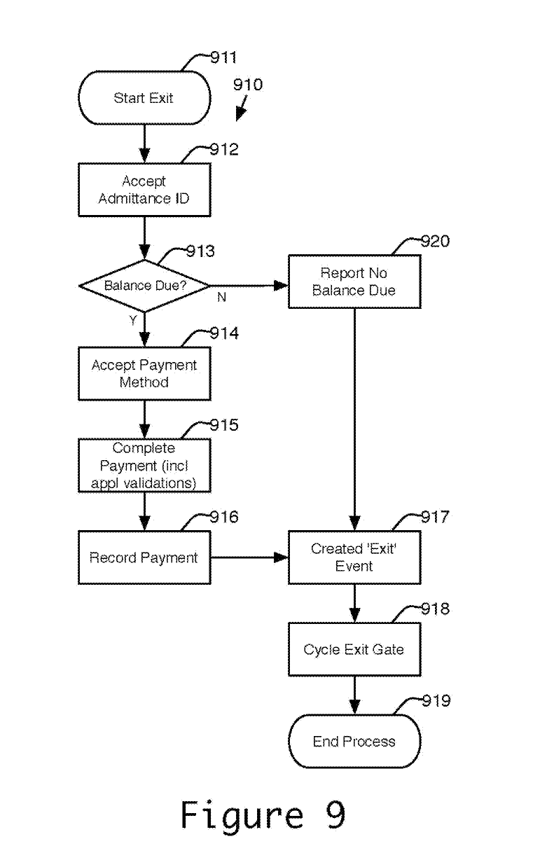

In automated exit lane 180, the patron, from his car, presents his parking ticket or other identification to automated exit kiosk 183 in an exit process discussed in conjunction with FIG. 9. If correct payment has already been made, gate 181 is raised by actuator 182 and the patron, in his vehicle, exits parking lot 100. Otherwise a payment transaction (such as that in FIG. 8) is needed first. In some embodiments, such a transaction can be conducted by automated exit kiosk 183, otherwise the patron is referred to automated payment kiosks 170, 171 or attended exit lane 190.

In attended exit lane 190, the patron, from his car, presents his parking ticket or other identification to attendant 194 in exit booth 193. Parking register 196 sits on desk 195, and attendant 194 presents the parking ticket or identification to the register 196 to be read. The exit process is performed by register 196, with the aid of attendant 194, verifying, or if necessary, collecting the payment (per FIG. 9). At the end of the exit process, actuator 192 raises gate 191 and the patron, in his vehicle, is able to exit parking lot 100.

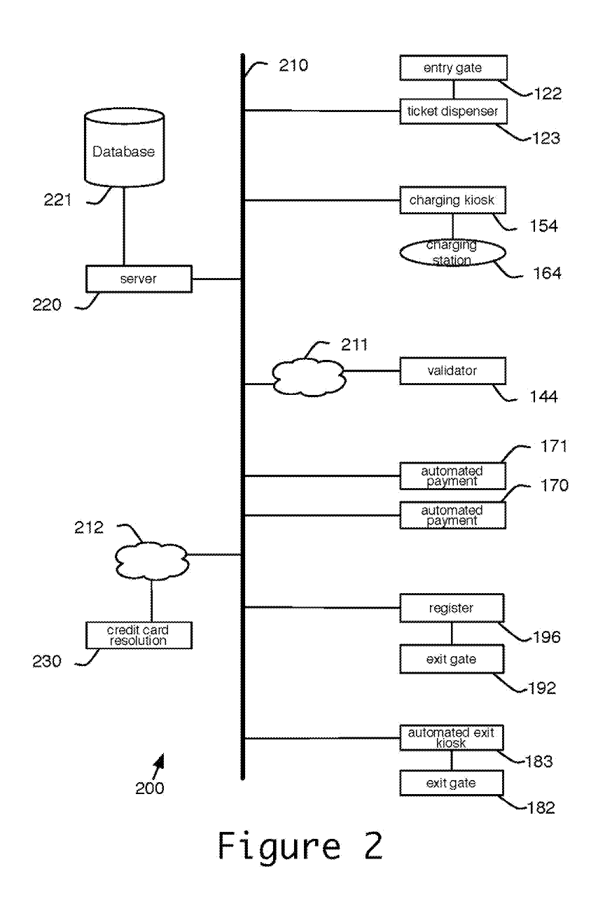

FIG. 2 shows a block diagram of one embodiment of parking lot management system 200 of the present invention. Communication channel 210 provides communication between server computer 220 (or other computer) and interconnected elements of parking lot 100 shown in FIG. 1, including ticket dispenser 123, charging kiosk 154, automated payment kiosks 170, 171, automated exit kiosk 183, and parking register 196. Communication channel 210 may include wireless links (not explicitly shown), or may be entirely wired. Communication channel 210 may comprise standard data communications gear, including, for example routers and switches that employ Internet Protocol standards. Communication channel 210 may comprise telephone equipment and modems (none shown).

Gate actuators 122, 182, and 192 may be connected directly to corresponding elements such as ticket dispenser 123, automated exit kiosk 183, and parking register 196 (as shown); or in an alternative embodiment they may controlled through a connection (not shown) with communication channel 210.

In some embodiments, validator 144 has a connection with communication channel 210. The connection between communication channel 210 and validator 144 may be direct (not shown), or it may through connection 211 using the Internet or telephone system.

Server 220 and connected database 221 represent the computational capability for tracking the status of parking tickets issued by ticket dispenser 123, and/or other identifications previously issued, as they are used to enter and exit parking lot 100. One embodiment of database 221 is discussed below in conjunction with FIG. 3. Those skilled in the art will recognize that server 220 and database 221 may be implemented using any of many different architectures which may be selected to provide attributes of centralization (e.g., a remote central server providing management capabilities to many parking lots), redundancy (e.g., server 220 may represent a plurality of servers each capable of performing the necessary functions, even as some of the servers fail or lose communication with channel 210), and cost (e.g., the functionality of server 220 and database 221 could be embedded in parking register 196), among others. Similarly, in the illustrated embodiment of FIG. 2, database 221 is directly connected to server 220. However, in alternative embodiments, server 220 could interact with database 221 through communication channel 210 or a separate communication channel (not shown), as with server 220, the implementation of database 221 may be selected to provide different attributes of centralization, redundancy, cost, among others; none of which are germane to the nature of the present invention.

For use with credit cards or other external payment methods (e.g., debit cards), communication channel 210 may further provide a connection 212, which may include the Internet, to a credit card resolution service 230. Transactions with credit card resolution service 230 may be conducted directly by charging kiosk 154, automated payment kiosks 170, 171, automated exit kiosk 183, or parking register 196. Alternatively, transactions with credit card resolution service 230 may be conducted indirectly through server 220. In still another embodiment (not shown), charging kiosk 154, automated payment kiosks 170, 171, automated exit kiosk 183, and parking register 196 may comprise a modem or other communications interface (not shown) and transact with credit card resolution service 230 through a connection (not shown) other than through communication channel 210.

An example embodiment of database 221 is shown in

FIG. 3. This embodiment shows database 221 as a series SQL tables and relationships, which are well suited for describing the present invention's data and transactions. Those skilled in the art are aware of many alternative embodiments for data storing and paradigms for manipulating the data (including ISAM databases, stored procedures for queries, XML representations of data, web services for data transactions, and even spreadsheet representations). Many well known database implementations and methodologies are applicable to the requirements of the present invention, and

SQL is chosen for this illustration for being well known, efficient, and well suited to transactional access.

Database 221 is shown having tickets table 310 and identifications table 320, together tracking all of the forms of identification for use by parking lot management system 200.

Tickets table 310 is for tracking parking tickets issued by ticket dispenser 123, and comprises fields for ticket identification number (TicketID field 311, each of which in this example is a 5-digit number beginning with ‘10’ and ending with the three digits corresponding to the identifier of cars 124, 130, and 150), gate of issue (IssueGateID field 312, which, since this example has only one ticket dispenser 123, is always ‘1’), time of issue (Issued field 313), and current status (StatusKind field 314). In this discussion, current status is one of ‘Active’, for parking tickets associated with vehicles that are considered to be in parking lot 100; ‘Closed’, for parking tickets associated with vehicles that have left parking lot 100; and ‘Expired’, for parking tickets which are old, but somehow not believed to be associated with any vehicle still in parking lot 100 (e.g., a parking ticket unaccounted for, even when the parking lot is empty).

The entries shown in tickets table 310 are: #10124, for car 124, issued at 7:36 AM and still active; #10130 for car 130, issued at 7:15 AM and still active; #10153 for car 153, issued at 7:24 AM and still active; #10800 for a car no longer in parking lot 100, issued at 7:00 AM, and now closed; and, #10999 issued yesterday and expired because it is not believed to represent any cars presently in parking lot 100. Records associated with expired tickets, such as #10999, may be investigated and/or removed from the active portion of the database periodically. Similarly, records associated with closed tickets may be similarly removed from the active portion of the database, for instance nightly, or weekly, or on some other maintenance schedule, to keep the database from growing unbounded and becoming slow. It is useful to keep the active portion of the database small, as this can make it faster, more reliable, easier to replicate (e.g., for implementations where database 221 is stored in multiple locations).

Identifications table 320 is for tracking identifications previously issued, and usable with (though not necessarily issued by) parking lot management system 200. In this embodiment, the identification ID number (IdentID field 321) is a five digit number, whose first two digits are ‘20’ and whose last three digits correspond to the vehicle whose parking it presently tracks. Of the five identifications listed in table 320, only the first one, #20163 having current status (Status field 323) of ‘In’, represents car 163, presently in parking lot 100. The other four identifications do not correspond to a car presently in the lot, and so have current status (Status 323) of ‘Out’. Identification table 320 may also include other data regarding each entry, such as the name of the holder (Name field 3222).

In this embodiment, an identification would have the identification ID number (IdentID field 321) printed on the identification or otherwise machine readable from it (e.g., as a barcode, magnetic stripe, or embedded in an RFID). In another embodiment, the value printed on or readable from a barcode, magnetic stripe, or RFID on the identification might be distinct from the IdentID field 321, in which case a separate but corresponding value field would be included in identifications table 320. Likewise, if the identifications to be used were a drivers license, credit card, fingerprints, facial recognition, speech pattern, or other artifact or biometric measure, then data about that identification (or its location, if stored on a remote server, not shown) would be stored in identifications table 320 in another identification field (not shown). In use, when this other identification was matched (e.g. by a facial recognition algorithm), the corresponding identification ID number in the same record would be used.

Events table 330 records each transaction corresponding to the parking tickets and identifications in tables 310 and 320. Each record in events table 330 has a unique event ID (EventID field 331) and is tied to exactly one admittance identification, logged as an admittance ID type (AdmitType field 332) and an admittance ID number (AdmitID field 333). In combination, the AdmitType and AdmitID fields identify exactly one parking ticket from table 310 (if AdmitType=‘Ticket’) or identification from table 320 (if AdmitType=‘Ident’). The AdmitID field 333 matches a parking ticket ID number entry from the TicketID field 311 or an identification ID number from the IdentID field 321, with which table being the source for the match depending upon the value of the admittance ID type (from AdmitType field 332). The “event-is-associated-with-which-identification” relationship 339 is a bifurcated one, with each record in event table 330 corresponding to exactly one record in either tickets table 310 or identifications table 320; but each record in tables 310 and 320 corresponding to zero or more records in events table 330.

For each transaction in events table 330, a transaction kind is recorded (in EventKind field 334), as is the time the event occurred (in EventTime field 335).

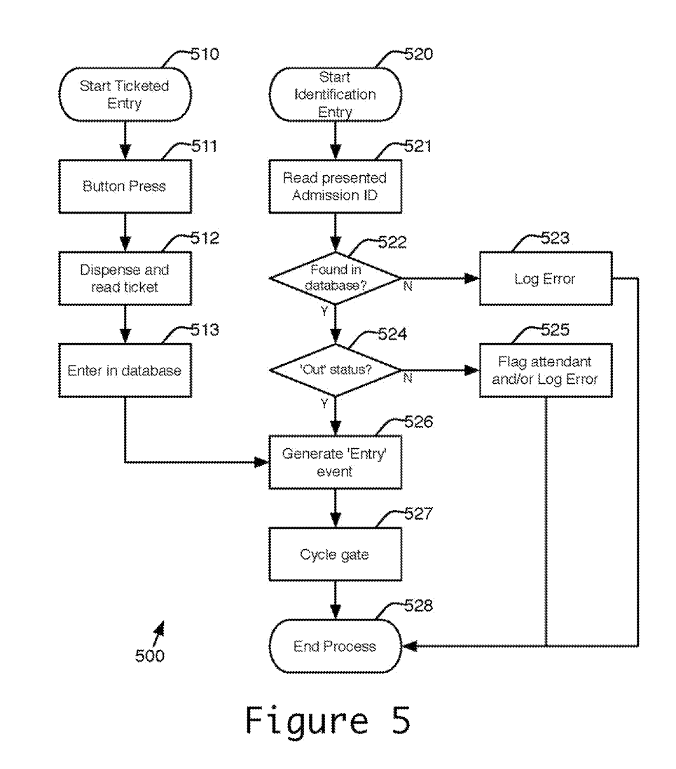

For clarity in this presentation, the events table 330 is presented in chronological order, though this is not required. Further, the values for event ID (EventID field 331) are each four digits long, with the first two digits being ‘30’ and the last two digits being in order, in the sequence ‘01’ to ‘14’. This for is for clarity of presentation only. In the discussion here, the transaction kind (EventKind field 334) can have the values of ‘Entry’, ‘PlugIn’, ‘Validation’, ‘PlugOut’, ‘Checkout’, and ‘Exit’, which will be discussed below, especially in the context of the flowcharts of FIGS. 5, 6A, 6B, 7A, 8, and 9.

Certain events require data beyond what is shown in the fields 331-335 of events table 310. For these events, additional information can be stored in companion tables 340 and 350.

Validations table 340 stores additional information about a validation for events having EventKind field 334 equal to ‘Validation’. Examples of additional information about a validation includes the amount of time for the validation (i.e., how much parking credit a vendor has granted the patron), as shown in Duration field 343; which validator produced the validation (in this example, #40144 corresponds to validator 144, the only one shown in FIG. 2), as shown in ValidatorID 344; and the identify of the vendor (in this example, #30140 corresponds to vendor 140, the only one shown in FIG. 2).

Event-validation relationship 349 requires that each record in Validations table 340 have a correspondence to exactly one record in events table 330, but that each record in events table 330 may have a correspondence to zero or one records in validations table 340 (and will only have one for those event records having EventKind 334 equal to ‘Validation’). Records in validations table 340 may each be uniquely identified by a validation record number (ValidationID field 341) for reporting purposes and for association with subsequent payment records in payments table 350.

Payments table 350 stores additional information for financial transactions relating to events having EventKind field 334 equal to one of ‘PlugIn’, ‘PlugOut’, ‘Checkout’, and ‘Exit’. One example of additional information about financial transactions relating to events include which station performed the financial transaction (Station field 353). In this example, values are ‘0’ followed by the system element identifier, i.e., ‘0154’ for charging kiosk 154, ‘0170’ for automated payment kiosk 170, and ‘0196’ for parking register 196. Note that entries relating to charging kiosk 154 further have a ‘−1’ and ‘−2’ suffix representing a payment made for either a vehicle in charging space #1 or #2, as called out by indicia 156 and 166, or otherwise associated with parking spaces 150 and 160.) Other additional information may include what the payment is for (PaymentKind field 354), such as ‘PlugIn-Reserve’, ‘PlugOut-Validated’, ‘Exit-Already Paid’, and ‘Checkout’, which correspond to specific financial transactions in accordance with a facilities management policies (discussed further below). For those payments that are altered because of a validation, a reference to the record in validations table 340 is recorded in Validation field 355, and is the validation ID number (ValidationID field 341) of the corresponding record. This forms payment-validation relationship 358. The amount and type of the payment is noted in Amount field 356 (wherein the kind of ‘reserved’ corresponds to a credit card transactions wherein an authorization is obtained, perhaps for an amount greater than may eventually charged, i.e., perhaps a day's worth of parking; and the kind ‘closeout’ corresponds to a credit card transaction wherein the settlement is performed, generally for an amount less than or equal to a previously ‘reserved’ amount (though possibly more, i.e., if someone parks for five days, when the reserve was only for a day's parking). Those skilled in the art will recognize that credit card transaction numbers, authorization numbers, merchant IDs, and other information common in credit and debit card processing are being glossed over in this discussion by the simple expression in Amount field 356, but that the meaning, with respect to the pertinence and value to the present invention, is clear.

Event-payment relationship 359 requires that each record in Payments table 350 have a correspondence to exactly one record in events table 330, but that each record in events table 330 may have a correspondence to zero or one records in payments table 350 (and will only have one for those event records having EventKind 334 equal to ‘PlugIn’, ‘PlugOut’, ‘Checkout’, or ‘Exit’). Records in payments table 350 may each be uniquely identified by a payment record number (PaymentID field 351) for reporting purposes.

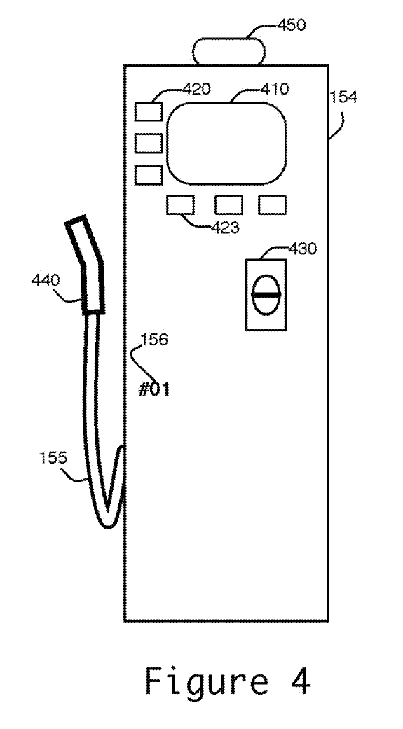

FIG. 4 shows one embodiment of charging kiosk 154, showing display 410, which may comprise a touchscreen, for advertising the charging kiosk's operational status, pricing, and for presenting a user interface during transactions (with the touchscreen accepting responses). Various buttons, such as buttons 420 and 423, may also be provided in charging kiosk 154 for use in the user interface, for example to select whether the car in question is located in parking location 150 (#1) or 160 (#2). Reader 430 may read parking tickets issued by ticket dispenser 123, other identifications recognized by the parking lot management system 200 (e.g., RFIDs), and credit or debit cards. If charging cable 155 is attached to charging kiosk 154, then in one embodiment, plug 440 is an SAE J1772 plug or other widely adopted standard suitable for use in many makes of EV. Alternatively, instead of presenting cable 155, one or more electrical outlets (not shown) suitable for a patron's own electrical cable 155 may be provided, in which case plug 440 may be specifically adapted to the patron's vehicle.

Additionally, charging kiosk 154 may provide an indicator 450, which may be on the body of kiosk 154, or may be several feet above and/or away from it, to indicate which charging kiosks are available (i.e., not occupied, signaled by indicator 450 lighting up green), which are charging (i.e., paid for, signaled by indicator 450 going dark) and which are in violation (i.e., occupied, but not paid for, for use in flagging down parking enforcement, signaled by indicator 450 lighting up red).

FIG. 5 is a flowchart showing one embodiment of vehicle entry process 500 as initiated by a patron entering through entry lane 120. Entry process 500 starts at ticketed entry step 510 or identification entry step 520, depending on whether the patron presses a ‘dispense ticket’ button (not shown) on ticket dispenser 123, or presents a pre-issued identification to an identification sensor (not shown). In dispense ticket button press step 511, the button is pressed by the patron, and ticket dispenser 123 dispenses a ticket while simultaneously reading its ticket number in dispense step 512. In ticket registration step 513, ticket dispenser 123 triggers the creation of a record in tickets table 310 by communicating a registration with server 220 through communication channel 210, and using the ticket identification number read in step 512. Once the ticket is registered, processing continues with entry generation step 526 by generating an event of EventKind 334 ‘Entry’ with an EventTime 335 set to the current time, an AdmitID 333 set to the ticket identification number from step 512, and an AdmitType 332 ‘Ticket’. Actuator 122 is commanded to open gate 121 and allow the entering vehicle to pass in cycle gate step 527, at which point entry process 500 concludes at step 528 and awaits the next vehicle.

When an identification is presented and then read in read identification step 521, processing continues at step 522, where an examination is made of database 221, to see if the identification read in step 521 appears in identifications table 320. If not, processing continues by logging the error in step 523, and terminates at step 528. Otherwise, the status from the corresponding record in identifications table 320 is examined.

If the identification is listed with a status of ‘In’, that means the database records indicated that the identification read in step 521 is already associated with a vehicle currently believed to be parked in lot 100 (or perhaps in a co-managed lot, if database 221 is being used in the management of multiple parking lots). Resolution step 525 may merely log the error, or summon an attendant, or take some other action, according to management policy.

If the identification is listed with a status of ‘Out’, that means the database records indicate that there is no current records of a vehicle within parking lot 100, and so the one in entry lane 120 may be admitted. As before, an entry event is generated in step 526, but this one lists an AdmitID 333 set to that read in step 521 and an AdmitType 332 of ‘Ident’.

FIG. 6A is a flowchart showing an embodiment of plug-in process 610 as executed by a patron at charging kiosk 154 in conjunction with server 220 and database 221 over communication channel 210 as the patron wishes to connect his EV to a charging station. PlugIn process 610 begins in step 611 with the patron parking in an empty charging space (e.g., 150, 160) and approaching charging kiosk 154.

The patron then presents the admittance ID used in the entry transaction 500, that is the parking ticket issued by dispenser 123, or the identification read in step 521. In accept admittance ID step 612, charging kiosk 154 reads the admittance ID with reader 430.

Accept payment method step 613 may vary according to policy. If the admittance ID is an identification associated with monthly parking privileges, the payment method would default and no query of the patron would be required. If the charging kiosk only accepts cash, that can be indicated on display 410, and if policy requires advance payment, then the process would wait for money to be inserted into a bill reader (not shown) on kiosk 154. If a lot's clientele are statistically trustworthy, the payment method acceptance step 613 may result in no payment method accepted at this time. This may also be the case when the person initiating the PlugIn process is not the patron, but a valet (a valet may provide a special ID, not shown, to be read by reader 430, or passcode or other form of privileged access, to enable this selection). If billing of vehicular charging is handled automatically by another entity, (e.g., by the electric utility who may have provided an electrical meter, not shown, that will communicate with the EV, for example through charging cable 155, and bill the registered owner of the vehicle directly), then again payment method acceptance step 613 will automatically select this mode of payment when the vehicle is connected. Most commonly, however, at least in the near term, a prompt on display 410 (or elsewhere) indicates pricing for parking in a spot that includes EV charging and the acceptable forms of payment. In response, the patron will elect to pay with a credit or debit card (with the election being made, for example, by pressing credit select button 420) and will presented such a card to reader 430. Having read the card with reader 430, charging kiosk 430 communicates either directly or through server 220 with credit card resolution service 230 to authorize the card.

Regardless of the payment method chosen by the patron or applicable policies, a ‘PlugIn’ event is generated in step 614. This creates another record in events table 330 with a unique EventID 331 and having an association 339 with the corresponding record in table 310 or 320, and EventKind 334 of ‘PlugIn’, and the current time in EventTime 355.

If a credit or debit card was authorized, a corresponding record is created in payments table 350, with a unique PaymentID 351, and having the appropriate relationship 359 with the just-made PlugIn event record (that is, EventID 352 matches that of the just-made EventID 331). In this new payment record, Station 353 is set to indicate ‘0154-1’ (presuming that parking location 150 was indicated, as opposed to parking slot 160, for example with charging location select button 423). PaymentKind 354 is set to ‘PlugIn-Reserve’ to indicate that the transaction was carried out at the start of a vehicle charging session and is an authorization, not necessarily a final price. Of course, other policies may be selected, for example, to charge a flat rate for EV charging, in which case that amount might be charged at this time, and the PaymentKind 354 may be selected to denote that. For this kind of transaction, Validation field 355 is empty. The Amount field 356 would be set to the amount authorized, which would generally have been set by policy (e.g., the advertised value of eight hours of charging).

In charging enable step 615, the charging station indicated by the patron (if more than one was available) is enabled. In this case, the station is charging kiosk 154, but had #2 (parking spot 160) been selected, then charging kiosk 164 would have been enabled.

In connect and charge step 616, the patron connects charging kiosk 154 to his EV with cable 155 (or charging kiosk 164 to his EV with cable 165, if parking spot 160 was indicated). Charging of the EV begins.

Upon the successful start of charging the vehicle, telltale indicator 450 may be extinguished, or set to a color, e.g., yellow indicating that the parking space is no longer available, but neither is there a violation (i.e., unpaid parking at a EV charging station).

PlugIn process 610 terminates at step 618 with the vehicle continuing to charge.

FIG. 6B is a flowchart showing an embodiment of plug-out process 620 as executed by a patron at charging kiosk 154 in conjunction with server 220 and database 221 over communication channel 210 as the patron, in step 621, is disconnecting his vehicle from a charging station. In step 622, the charging of the vehicle is halted, either because the charge has completed and the vehicle has ceased to draw significant current, the charging kiosk 154 or vehicle 153 has received a signal to halt charging (either a timer has expired, or the patron has pressed a button on the charging kiosk, cable plug 440, or within the vehicle 153, or plug 440 is removed from the vehicle interrupting the charging circuit (the latter is not ideal).

Following the cessation of charging in step 622, telltale indicator 450 may be updated in step 623, according to policy. For instance, if charging of a vehicle has just be manually interrupted (i.e., by pressing a button), then the indicator may be set to green, indicating a charging parking space 150 imminently opening up. Alternatively, the update to indicator 450 can be delayed. In another embodiment, if the vehicle has stopped charging, indicator 450 may change to a color to indicate that the charge is done (i.e., in case indicator 450 can be by a patron in a neighboring business 140).

In step 624, the patron (or valet) disconnects cable 155 from vehicle 153. This can be detected electronically (e.g., sensing a change in the termination of plug 440), or mechanically (e.g., sensing cable 155 returning to a switch-hook, not shown, on charging kiosk 154), or manually (e.g., the patron or valet indicating that the vehicle has been disconnected).

In response to the disconnection of step 624, a ‘PlugOut’ event is generated. The PlugOut event is related to the PlugIn event generated in step 614. The AdmitType 332 and AdmitID 333 can be copied from the most recent PlugIn event having the same Station 353 entry in a corresponding record in payments table 350 (or in another embodiment, the patron may be required to present the parking ticket or identification used in the PlugIn process 610). The EventKind 334 is ‘PlugOut’. In the corresponding payment record in payments table 350 the PaymentKind 354 indicates a PlugOut. One such value for PaymentKind is ‘PlugOut-Validated’ which is set when event table 330 contains an event with EventKind 334 ‘Validation’ for the same AdmitID 333 & AdmitType 323 as the PlugOut event, in which case the ValidationID 341 for the record in validations table 340 corresponding to the validation event is entered into Validation 355.

Pay now decision step 627 determines whether, by policy, a payment is to take place now, or upon exit. If not now, then plug-out process 620 terminates here at step 632. Otherwise the payment process is undertaken now at step 628.

In payment step 628, payment may comprise a portion due for the amount of time spent parked in parking slot 150. The amount of this portion may be different, depending upon the maximum available charging rate available at charging kiosk 154 (since higher capacity chargers may be in greater demand than lower capacity chargers, because of the more convenient, shorter charge time). The payment may be wholly, partially, or not at all offset by zero or more validation records. (Note: While database 221, as shown, only illustrates a single validation applied to a payment record in table 350, Validation field 355 could contain a list of applicable ValidationIDs, if management policy permits.)

In integration check step 629, if charging kiosk 154 is integrated with the parking lot management system 200 as shown in FIG. 2, then the payment is recorded in step 630 by completing the Amount field 356 with the computed amount, and the credit/debit transaction is settled for the computed amount, and the plug-out process terminates at step 632.

However, in an alternative embodiment, where the primary parking lot management system producing entry and exit transactions from entry lane 120 and exit lanes 180, 190 is not in communication with charging kiosk 154, then integration check step 629 passes control to ticket validation step 631, where a parking ticket validator (not shown, but similar to validator 144 and using a validation process, for example as discussed in conjunction with FIG. 7A or 7B, below) is signaled by charging kiosk 154 to validate the parking ticket for an amount of time determined by policy (e.g., for a predetermined amount of time, an interval of time equal to the amount of time spent charging, a predetermined dollar amount, or a dollar amount based on the payment finalized in step 628). In this way, a parking lot management system that is otherwise not connected to charging kiosks 154 can allow a patron who has parked in slot 150 and paid at charging kiosk 154 to exit with reduced or no further payment (discussed further in conjunction with FIG. 9, below). Following validation step 631, plug-out process 620 terminates at step 632.

Referring now to FIGS. 7A and 7B, validator 144 (or a validator to be used in validation step 631) can operator according to automatic validation process 710, or manual validation process 720.

In automatic validation process 710, a patron such as business patron 143 presents an admittance ID in start electronic validation step 711. The admittance ID is read in step 712 and found in one of tables 310 and 320. A validation event record is created in step 713, in events table 330 having a unique EventID value, an AdmitID 333 and AdmitType 332 corresponding to the admittance ID read in step 712. EventKind 334 is set to ‘Validation’, and EventTime 335 set to the current time. A corresponding validation record is added to validations table 340, with a unique ValidationID 341, an EventID corresponding to the validation event just created (to create relationship 349 between the two records), with the settings of Duration 343 for an interval of free or discounted parking (or otherwise recording whatever benefit accrues as a matter of policy for the validation. ValidatorID 344 and VendorID 345 are set according to predetermined settings associated with validator 144.

In manual validation process 720, the patron desires validation for parking at step 721. A test is made at step 722, for whether the ticket is available. If yes, the ticket is marked in step 724 as validated (e.g., by a punch or stamp) and manual validation process 720 concludes in step 725. If the ticket is not available in step 722, then in step 723, a receipt is provided, e.g., from vendor 140, which may be a commerce receipt marked as the ticket would have been in step 724, and again the process terminates at step 725. Note that a validation obtained through manual validation process 720 can only be processed through attended exit lane 190, neither automated payment kiosk 170, 171, nor automated exit kiosk 183 will support manual validations.

Though validator 144 is the only one shown in FIG. 1, in another embodiment in which a charging station inside parking lot 100 does not directly communicate with the balance of parking lot management system 200, but is adapted to communicate directly with a validator (not shown, but similar to validator 144) of the parking lot management system. Such a charging station may have its own database for plug-in and plug-out events, and payments, it may have its own communication connection to an external service for financial transactions. The communication with the validator enables the charging station to validate parking tickets as does validator 144, and offer an easy exit from parking lot 100 after a payment to the charging station results in a validation that reduces or eliminates payment otherwise due on the parking ticket so validated. Alternatively, the charging station can have no communication with external services for financial transactions, but instead rely on validating the parking ticket in a way that—increases—parking fees when exiting, rather than reducing them. This can allow a particularly simple charging station to operate and collect no payments itself, but validate the parking ticket in a way where the incremental fees for parking in an EV charging space are still levied. In these alternative embodiments wherein a charging station controls a validator rather than having a direct connection to the parking lot management system 200, the ValidatorID 344 and VendorID 345 would be predetermined values set for the charging station if automatic validation process 710 is used. However, if manual validation process 720 is used, then the validation can only be processed at attended exit lane 190.

FIG. 8 shows automated payment process 810 for use with automated payment kiosks 170, 171 but which may also be used by automated exit kiosk 183 and parking register 196.

Automated payment process 810 begins in step 811 with the patron presenting his admittance ID, for example to automated payment kiosk 170. In step 812, the admittance ID is accepted if found in one of tables 310 and 320 and processing continues at step 813.

In charging test step 813, the admittance ID accepted in step 812 is used to search events table 330 for a plug-in event not paired with a plug-out event. Such an unpaired plug-in event would indicate that the vehicle associated with the presented admittance ID is still connected to a charging station 154, 164. Policy may require (as is illustrated in FIG. 8) that the payment transaction take place at the charging kiosk 154, in which case a display (not shown) on the payment kiosk 170 can direct the patron to the charging kiosk 154, in accordance with step 814. (In an alternative embodiment, in which charging kiosks and payment kiosks are sufficiently interconnected, policy may allow a plug-out transaction process 620, at least in part, including payment, to be conducted remotely from automated payment kiosk 170.)

If charging test step 813 determines that no charging is taking place (i.e., there are no paired plug-in events associated with the admittance ID), a balance due test is made in step 815. The balance due test examines the events associated with the presented admittance ID. If the combination of events represent a parking interval, validations, payments, and charging intervals such that, according to policy, no balance is outstanding, then in step 816 a ‘Checkout’ event is recorded with the zero balance due noted (see the description of a checkout event in step 820, below), and in step 817 the patron is directed to exit and the automated payment process 810 terminates at step 830. Otherwise, the patron is presented with payment options and a payment method is accepted is step 818 (e.g., the patron chooses cash, or selects a credit card for payment). In step 819, the remaining balance is paid using the selected method, and in step 820 a ‘Checkout’ event is recorded in events table 830. A checkout event has an EventKind 334 of ‘Checkout’ and is associated with a payment record in payments table 350. Applied validations are noted in Validation field 355 and any charges (e.g., to a credit card) are noted in Amount field 356. (In the case of a zero-balance entry, as from step 816, the Amount field 356 would be empty.)

With the checkout event recorded, the automated payment process 810 concludes at step 830.

When the patron is exiting in either of lane 180 (using the automatic exit kiosk 183) or lane 190 (in which the attendant 194 will use parking register 196), exit process 910 is performed. The exit process 910 is started with step 911 in which the patron presents the admittance ID used for this parking session, either to the automated exit kiosk 183, or to attendant 194 who in turn presents it to the parking register 196. In step 912, which is very similar to accept step 812, the admittance ID is found in database 221. Step 913 is very similar to balance due test step 815. If no balance is outstanding, in step 920, the kiosk 183 or register 195 indicates no balance is due and an exit event is created in step 917 (and is discussed further below following step 916). If a balance is due at test step 913, the process continues with accept payment method step 914 (similar to step 818), complete payment step 915 (similar to step 819), and record payment steps 916 (similar to step 820) each are performed. Record payment step 916 may differ from record payment step 820 in that that in exit process 910, the payment is recorded and linked (via event-payment relationship 359 to the exit event record created in step 917. The exit event is a record in events table 330, and has EventKind 334 set to ‘Exit’. The associated payment record have a PaymentKind 354 set to values such as ‘Exit-Already Paid’ (for instance, if payment had already been made). The value might be ‘Exit-Validated’ if a validation is used (and whether an embodiment chooses to distinguish among such situations as ‘Exit-Validated-Paid’ and ‘Exit-Validated-No Charge’ in PaymentKind 354 rather than requiring further examination of fields such as Validation 355 and Amount 356, is up to the implementer).

As the exit event is created, a status update may be made in tickets table 310 that the corresponding ticket's StatusKind is ‘Closed’ (if AdmitType 332 for the event was ‘Ticket’) or in identifications table 320 that the corresponding identification's Status 323 is now ‘Out’ (if AdmitType 332 for the event was ‘Ident’).

With the exit event logged, the corresponding actuator 182 or 192 can open respective gate 181 or 191 to allow the patron, in his vehicle, to exit.

From the records shown in FIG. 3, and from the above explanation, one can follow the activities occurring in parking lot 100, up to the current state as shown in FIG. 1. For example:

At 7:00 AM a vehicle entered parking lot 100 and was issued ticket #10800 (per event #3001). The parking ticket was issued at entry lane 120 (from the issue gate of ticket #10800).

One minute later, (per event #3002, the next event having the same AdmitID 333) this vehicle was plugged into charging kiosk #154 (0154-1) and an authorization for $5 was placed on a credit card (per payment record #5001).

At 7:12 AM, (per event #3005) this patron received a validation for 30 minutes of parking (validation #4005) from validator 144 (#40144) operated by vendor 140 (#30140).

At 7:23 AM, (per event #3007), this vehicle was disconnected from charging kiosk 154 (0154-1) and a payment of $3 was calculated based on the validation #4005 and charged against the prior authorization (as shown by payment record #5003).

One minute later, (per event #3008) the patron exited from parking lot 100, in his vehicle, for no additional charge (seen from payment record #5004) from attended exit lane 190 (as recognized from payment station 0196 corresponding to parking register 196), whereupon the status of ticket #10800 was closed.

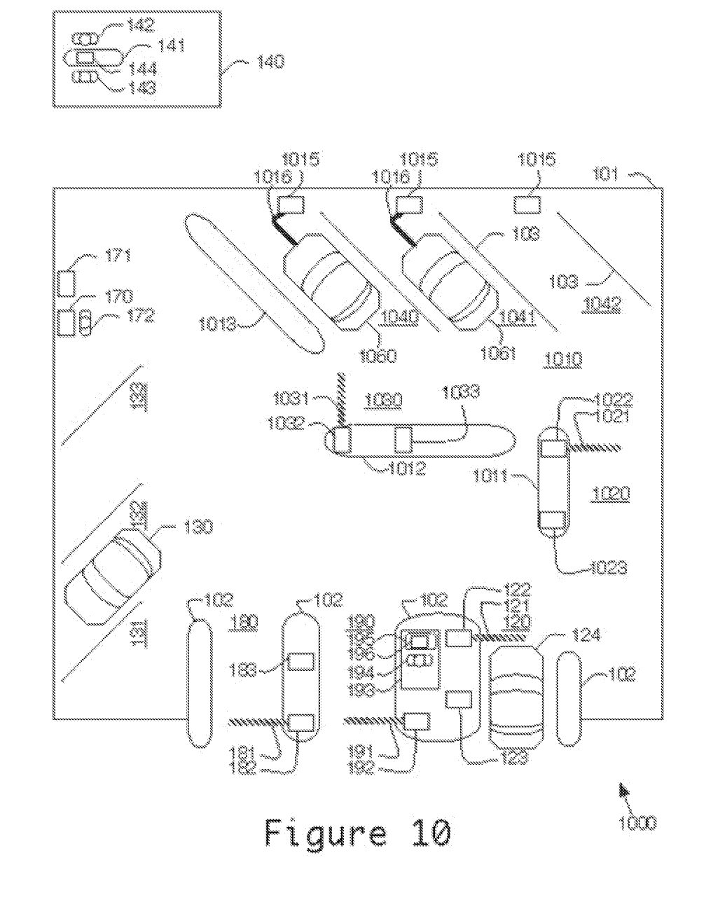

FIG. 10 shows another embodiment of the present invention, this one for parking lot 1000 managed by a system similar to 200.

In parking lot 1000, barriers 1011, 1012, 1013 and gates 1021 and 1031 separate controlled electric vehicle parking area 1010 from the rest of the parking lot 1000. Parking area 1010 contains parking spaces 1040, 1041, and 1042, all ready for EV charging due to their proximity to charging stations 1015. For a vehicle to enter parking area 1010 and gain access to a parking space with a charging station 1015, a patron must drive into EV parking lane 1020 and present an admittance ID to EV parking entry reader 1023, causing actuator 1022 to open gate 1021. Once in EV parking area 1010, the patron may park and connect his car to an EV charging station 1015 (e.g., with cable 1016, as have EVs 1060 and 1061). When charging is complete or the patron is otherwise ready to leave, the car is disconnected from charging station 1015 and the patron leaves EV parking area 1010 by presenting his admittance ID to EV parking exit reader 1033, whereupon actuator 1032 opens gate 1031.

To manage parking lot 1000, at least EV parking entry reader 10023 would be attached to communication channel 210, and thereby have communication with server 220 or other elements of parking management system 200. In this embodiment, it is not necessary for charging stations 1015 to be in communication with server 220. The operating presumption is that a car entered into EV parking area 1010 is or soon will be charging at one of the station. A transaction, similar to the plug-in process 610, is initiated at step 611 as the patron presents his admittance ID to EV parking entry reader 1023. The parking entry reader 1023 accepts the admittance ID (step 612) and the payment method defaults (in step 613) to payment as the patron is leaving. (In the alternative, if EV parking entry reader 1023 is equipped to accept a credit card, a policy of pre-paid access to EV parking area 1010 may be determined.) In step 614, a PlugIn event is generated in response to entry reader 1023, but charging station 1015 can be enabled continuously, so enable charging step 615 is not strictly required.

As the patron is ready to leave, a transaction similar to the PlugOut process 620 can be triggered as the patron presents his admittance ID to EV parking exit reader 1033 (in which case, the final action in the end process 632 is to signal actuator 1032 to open gate 1031).

Since direct control of charging stations 1015 is not required for transactions associated with EV parking area 1010, a transaction similar to payment kiosk process 810 can be nearly as effective: Instead of step 814 directing the patron to a charging kiosk (unneeded in parking lot 1000 because of the control exercised over EV parking area 1010) for a plug-out transaction, the modified plug-out transaction as just described can be executed in place of step 814. Under this arrangement, gate 1031 may be operated automatically, for example by a inductive sensor embedded in the roadway of exit lane 1033, as a vehicle tries to exit in lane 1030, in which case reader 1033 is not needed (or alternatively, a one-way tire-damage barrier may be placed across exit lane 1030, in place of gate 1031). In this embodiment, if a vehicle exits EV parking area 1010 without first performing the payment kiosk process 810 with the modified step 814, then in exit process 910, at either of exit lanes 180 and 190, an unmatched PlugIn event will be found for the admittance ID (e.g., in balance due calculation step 913) representing an implicit demand for a modified plug-out process 620 to generate the matching PlugOut event (or in the alternative, to allow unmatched plug-in events to be closed by a subsequent exit event.)

The advantage of the arrangement in parking lot 1000 is that management of the EV parking area 1010 can be accomplished by adding only the access control provided by gates 1021 and 1031, and barriers 1011, 1012, and 1013. The single entry gate 1021 manages access to an arbitrary number of charging stations 1015. As a result, charging stations 1015 may be considerably simpler than charging kiosk 154 (since no transaction at the charging station is strictly required). In the simplest form, charging stations 1015 may comprise only a powered electrical outlet (for use with the patron's own charging cable 1016), or in the alternative a hardwired charging cable 1016 may be provided.

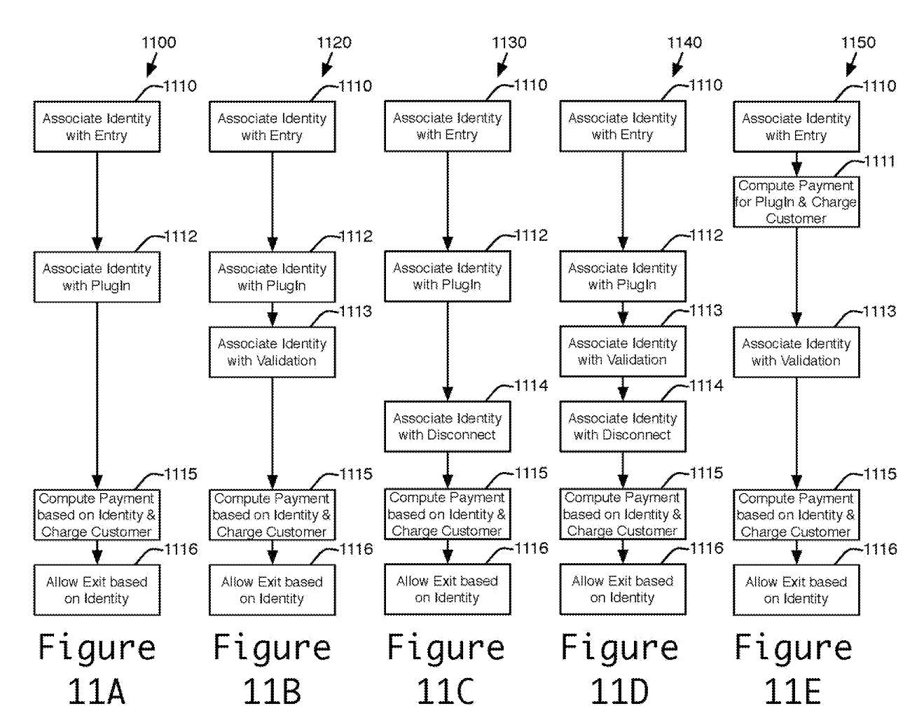

Individual processes 500, 610, 620, 710, 720, 810, and 910 may be embellished or streamlined, and combined together or used in different sequences, in accordance with the equipment and management policies selected for parking lots 100 or 1000. Such variations are well within the ordinary skill of practitioners in the field, given the teachings herein. Several such combinations are shown in FIGS. 11A-11E.

FIG. 11A shows parking lot management process 1100, in which: In entry step 1110, a admittance ID is associated with entry into the parking lot (e.g., 100 or 1000); in plug-in step 1112 the admittance ID is associated with an EV starting to charge (whether explicitly detected by charging kiosk 154, or implicitly presumed on the basis of entry into EV parking area 1010); in payment step 1115, computing payment and charging the patron based on the presentation of the admittance ID at any of automated payment kiosk 170, EV parking exit reader 1030, or either exit lane 180, 190; and, in exit step 1116, finally allowing the patron in his vehicle to exit the parking lot based on the admittance ID.

FIG. 11B shows parking lot management process 1120, which is similar to process 1100, except for the addition of validation step 1113, in which an admittance ID is associated (either manually or electronically) with a validation (e.g., by vendor 140), which may effect the payment computed in step 1115, in accordance with management policy.

FIG. 11C shows parking lot management process 1130, which is also similar to process 1100, except for the addition of plug-out step 1114, in which the admittance ID is associated with the EV ceasing to charge (whether explicitly determined by a plug-out transaction with charging kiosk 154, or implicitly presumed when exiting EV parking area 1010 if EV parking area exit reader 1030 is used, or when using either exit lane 180, 190 if EV parking are exit reader 1030 is not used, or at automated payment kiosk 170 in either case).

FIG. 11D shows parking lot management process 1140, which is similar to processes 1120 and 1130, but includes both steps 1113 and 1114.

FIG. 11E shows parking lot management process 1150, which includes payment step 1111 for EV charging, but wherein validation step 1113 is initiated based on the EV charging step 1111 and presentation of the admittance ID, rather than by presentation of the admittance ID to validator 144 of vendor 140. In this embodiment, the payment computed in payment step 1115 is reduced by the validation from validation step 1113, which may be predetermined, or may be proportional to the duration of the EV charging, in accordance with management policy. In particular, process 1150 allows a pre-existing parking lot management system operate effectively with EV charging stations, merely by providing an interface to a validator (as previously discussed above, in conjunction with FIG. 6B, especially step 631).

Process 1150 could be further extended by allowing a vendor 140 to provide an additional validation (repeating step 1113) which may be further considered in compute payment step 1115.

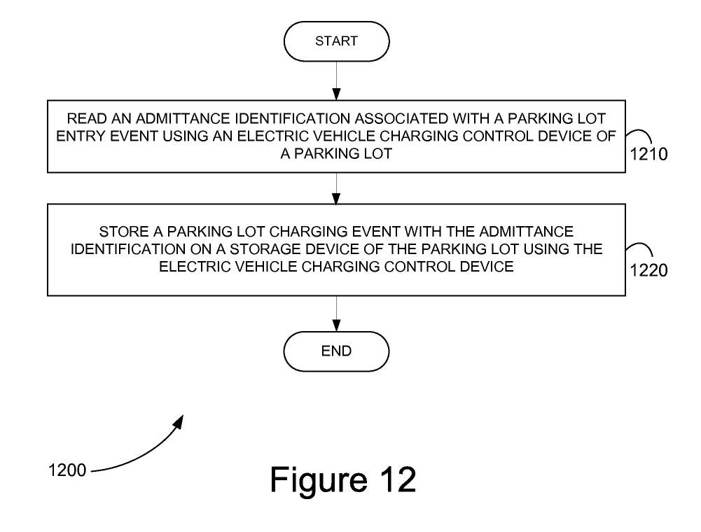

FIG. 12 is an exemplary flowchart showing a method 1200 for associating a parking lot parking entry event and a parking lot electric vehicle charging event, in accordance with various embodiments.

In step 1210 of method 1200, an admittance identification associated with a parking lot entry event is read using an electric vehicle charging control device of a parking lot. The admittance identification can be a parking ticket issued by a ticket dispenser of the parking lot, for example. In various embodiments, the admittance identification can be a reusable identification recognized by the ticket dispenser. The electric vehicle charging control device can be an electric vehicle charging kiosk, for example. In various embodiments, the electric vehicle charging control device can be a controlled electric vehicle parking area entry reader or a controlled electric vehicle parking area exit reader.

In step 1220, a parking lot charging event is stored with the admittance identification on a storage device of the parking lot using the electric vehicle charging control device.

The parking lot charging event can include a PlugIn event or a PlugOut event, for example. In various embodiments, the parking lot charging event comprises a controlled electric vehicle parking area entry event or a controlled electric vehicle parking area exit event.

The storage device can be a parking ticket, for example. In various embodiments, the storage device can be a database in communication with the electric vehicle charging control device.

In various embodiments, a payment authorization for the admittance identification is received and the payment authorization is stored as an authorization event with the admittance identification using the electric vehicle charging control device.

In various embodiments, the parking lot entry event and the parking lot charging event associated with the admittance identification are read from the storage device using a payment device of the parking lot. A single payment for parking and electric vehicle charging for the admittance identification is then calculated from the parking lot entry event and the parking lot charging event using the payment device. The payment device can include, but is not limited to, one of an automated payment kiosk, a credit card resolution service, automated exit kiosk, or a parking lot point-of-sale device.

In various embodiments, a parking lot validation event is stored with the admittance identification on the storage device using a validator. In various embodiments, the parking lot entry event, the parking lot validation event, and the parking lot charging event associated with the admittance identification are read from the storage device using a payment device of the parking lot. A single payment for parking and electric vehicle charging for the admittance identification is then calculated from the parking lot entry event, the parking lot validation event, and the parking lot charging event using the payment device.

FIG. 4 is a schematic diagram that illustrates a system, upon which embodiments of the present teachings may be implemented. A system for associating a parking lot parking entry event and a parking lot electric vehicle charging event can include a storage device of a parking lot (not shown) and electric vehicle charging control device 154.

As described above, the storage device can be a parking ticket, for example. In various embodiments, the storage device can be a database in communication with the electric vehicle charging control device. The database can include, but is not limited to, a magnetic device, an electronic device, an optical device, or any device capable of storing information.

As shown in FIG. 4, electric vehicle charging control device 154 can be an electric vehicle charging kiosk of a parking lot, for example. In various embodiments, electric vehicle charging control device 154 can be a controlled electric vehicle parking area entry reader or a controlled electric vehicle parking area exit reader of a parking lot.

Electric vehicle charging control device 154 reads an admittance identification associated with a parking lot entry event. Electric vehicle charging control device 154 then stores a parking lot charging event with the admittance identification on the storage device.

In various embodiments, a computer program product includes a non-transitory and tangible computer-readable storage medium whose contents include a program with instructions being executed on a processor of an electric vehicle charging control device so as to perform a method for associating a parking lot parking entry event and a parking lot electric vehicle charging event. This method is performed by a system that includes one or more distinct software modules. A processor can include, but is not limited to a computer, a microprocessor, a microcontroller, an application specific integrated circuit, a field programmable gate array, or any device capable of executing instructions and/or sending and receiving control signals.

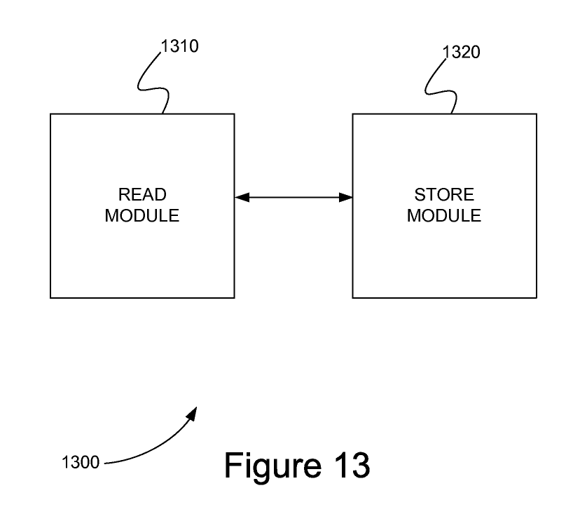

FIG. 13 is a schematic diagram of a system 1300 that includes one or more distinct software modules that performs a method for associating a parking lot parking entry event and a parking lot electric vehicle charging event, in accordance with various embodiments. System 1300 includes read module 1310 and store module 1320.

Read module 1310 of system 1300 reads an admittance identification associated with a parking lot. Store module 1320 stores a parking lot charging event with the admittance identification on a storage device of the parking lot.

Various additional modifications of the described embodiments of the invention specifically illustrated and described herein will be apparent to those skilled in the art, particularly in light of the teachings of this invention. It is intended that the invention cover all modifications and embodiments, which fall within the spirit and scope of the invention. For example, while many of the foregoing embodiments used a relational database paradigm because of its efficient and clear illustrative qualities, those skilled in the art will recognize that other data organizations and other software techniques can be used to achieve the results of the present invention. Thus, while preferred embodiments of the present invention have been disclosed, it will be appreciated that it is not limited thereto but may be otherwise embodied within the scope of the following claims.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A method for associating a parking lot parking entry event and a parking lot electric vehicle charging event, the method comprising:
reading an admittance identification associated with a parking lot entry event using an electric vehicle charging control device of a parking lot; and
storing a parking lot charging event with the admittance identification on a storage device of the parking lot using the electric vehicle charging control device.

2. The method of claim 1, wherein the admittance identification comprises a parking ticket issued by a ticket dispenser.

3. The method of claim 1, wherein the admittance identification comprises a reusable identification recognized by a ticket dispenser.

4. The method of claim 1, wherein the parking lot charging event comprises a plugin event or a plugout event.

5. The method of claim 1, wherein the parking lot charging event comprises a controlled electric vehicle parking area entry event or a controlled electric vehicle parking area exit event.

6. The method of claim 1, wherein the electric vehicle charging control device comprises an electric vehicle charging kiosk.

7. The method of claim 1, wherein the electric vehicle charging control device comprises a controlled electric vehicle parking area entry reader or a controlled electric vehicle parking area exit reader.

8. The method of claim 1, wherein the storage device comprises a parking ticket.

9. The method of claim 1, wherein the storage device comprises a database in communication with the electric vehicle charging control device.

10. The method of claim 1, further comprising receiving a payment authorization for the admittance identification and storing the payment authorization as an authorization event with the admittance identification using the electric vehicle charging control device.

11. The method of claim 1, further comprising reading from the storage device the parking lot entry event and the parking lot charging event associated with the admittance identification using a payment device of the parking lot and calculating a single payment for parking and electric vehicle charging for the admittance identification from the parking lot entry event and the parking lot charging event using the payment device.

12. The method of claim 11, wherein the payment device comprises one of an automated payment kiosk, a credit card resolution service, automated exit kiosk, or a parking lot point-of-sale device.

13. The method of claim 1, further comprising storing a parking lot validation event with the admittance identification on the storage device using a validator.

14. The method of claim 13, further comprising reading from the storage device the parking lot entry event, the parking lot validation event, and the parking lot charging event associated with the admittance identification using a payment device of the parking lot and calculating a single payment for parking and electric vehicle charging for the admittance identification from the parking lot entry event, the parking lot validation event, and the parking lot charging event using the payment device.

15. A system for associating a parking lot parking entry event and a parking lot electric vehicle charging event, the method comprising:
a storage device of a parking lot; and
an electric vehicle charging control device of a parking lot that reads an admittance identification associated with a parking lot entry event and stores a parking lot charging event with the admittance identification on the storage device.

16. The system of claim 15, wherein the electric vehicle charging control device comprises an electric vehicle charging kiosk.

17. The system of claim 15, wherein the electric vehicle charging control device comprises a controlled electric vehicle parking area entry reader or a controlled electric vehicle parking area exit reader.

18. The system of claim 15, wherein the storage device comprises a parking ticket.

19. The system of claim 15, wherein the storage device comprises a database in communication with the electric vehicle charging control device.

20. A computer program product, comprising a non-transitory and tangible computer-readable storage medium whose contents include a program with instructions being executed on a processor of an electric vehicle charging control device of a parking lot so as to perform a method for associating a parking lot parking entry event and a parking lot electric vehicle charging event, the method comprising:
providing a system, wherein the system comprises one or more distinct software modules, and wherein the distinct software modules comprise a read module and a store module;
reading an admittance identification associated with a parking lot entry event using the read module; and
storing a parking lot charging event with the admittance identification on a storage device of the parking lot using the store module.
